(19) United States
(12) Patent Application Publication
(10) Pub. No.: US 2017/0363282 A1
(43) Pub. Date: Dec. 21, 2017

(54) TEALIGHT AND HOLDER FOR A TEALIGHT CANDLE

(71) Applicant: WESTFIELD PLASTICS & MOLDING LLC, Westfield, MA (US)

(72) Inventor: CHRISTOPHER ARAUJO, STOCKBRIDGE, MA (US)

(73) Assignee: WESTFIELD PLASTICS & MOLDING, LLC, WESTFIELD, MA (US)

(21) Appl. No.: 15/628,779

(22) Filed: Jun. 21, 2017

Related U.S. Application Data
(60) Provisional application No. 62/352,678, filed on Jun. 21, 2016.

(51) Int. Cl. F21V 35/00

(52) U.S. Cl. CPC F21V 35/00

(57) ABSTRACT

A cup for a tealight includes a sidewall and a floor defining a generally cylindrical container, and an annular protrusion extending from a bottom surface of the container. The annular protrusion includes a first sidewall extending substantially perpendicular from the bottom surface of the container, a first radiused portion extending from the first sidewall, and a second radiused portion extending from the first radiused portion to the bottom surface.

### CROSS-REFERENCE TO RELATED APPLICATIONS

This application claims the benefit of U.S. Provisional Application Ser. No. 62/352,678, filed on Jun. 21, 2016, which is hereby incorporated by reference herein in its entirety.

### FIELD OF THE INVENTION

The present invention relates generally to candles and, more particularly, to a clear plastic cup or holder for a tealight candle.

### BACKGROUND OF THE INVENTION

Tealight candles, used for decorative or votive lighting or as a source of heat for a chafing dish, are candles formed by introducing wax into either metal or flame-resistant plastic cups around a central wick. The typical tealight candle burns for about 4-6 hours in cups of about 38 mm (1.5 in.) in diameter and 15 mm ( in.) in height.

Tealight candles are often mass produced using automated machinery and processes. Most typically, the cup which holds the wax is formed from tin. These tin cups are loaded by the hundreds or thousands onto conveyor belts which move the cups at high speeds through a sorting machine which ensures each cup faces open-side up. Additional conveyors transport the cups to an assembly machine where wax and a wick is inserted into the cup to form the tealight.

These tin cups, however, are very thin and are extremely prone to denting, distortion and deformation, particularly when being moved along the production line prior to the insertion of the wax. In particular, as the cups are transported along the assembly line at high speeds, they bump into one another and amass at bottlenecks, causing distortion of the sidewalls and/or floor of the cup. This distortion of the shape of the cup can cause jamming of machinery, which can require stoppage and downtime to clear the jam and remove any damaged cups. Often times, denting and distortion of the cups are caused by the speed at which the cups are run, as the cups are exposed to greater forces as they bump into one another at higher speeds. Accordingly, to minimize cup damage and therefore machine downtime, conveyor speeds are often kept below a threshold level. As will be readily appreciated, however, decreasing machine speeds also decreases throughput.

Aside from production challenges, existing tin cups are often quite unsightly to look at. Indeed, tin cups do not allow the bright and bold colors of the wax to show through; the color of the candle is only viewable from above. Recognizing this, efforts have been made to instead manufacture the cups that hold the wax out of clear plastic, such as by injection molding. Significant challenges have been encountered, however, when attempting to mass produce tealights with plastic cups. In particular, when running clear plastic cups through existing machinery, jamming has been particularly problematic, even at slower production speeds. This has been the case even when the plastic cups are manufactured to correspond rather exactly to the shape, profile and surface features of tin cups. It is thought that the added weight, wall thickness and typical bottom surface features of plastic cups make them particularly unsuited for, and incapable of, running on existing machinery.

In view of the above there is a need for a plastic tealight cup that can be run on existing mass-production machinery at high speeds without significant jamming or stoppages.

### SUMMARY OF THE INVENTION

It is an object of the present invention to provide a cup for a tealight.

It is another object of the present invention to provide a plastic cup for a tealight.

It is another object of the present invention to provide a plastic cup for a tealight that can be run on existing mass-production machinery at high speeds.

It is another object of the present invention to provide a plastic cup for a tealight that can be run on existing mass-production machinery at higher speeds than existing tin cups.

It is another object of the present invention to provide a clear plastic cup for a tealight.

These and other objects are achieved by the present invention.

According to an embodiment of the present invention, a holder for a tealight candle includes a floor, a sidewall extending upward from the floor, the floor and the sidewall defining a generally cylindrical container having an open top, and an annular protrusion on a bottom surface of the container.

According to another embodiment of the present invention, a holder for a candle includes a floor, a sidewall extending upward from the floor, the floor and the sidewall defining a generally cylindrical container having an open top, and an annular protrusion formed on a bottom surface of the container. The annular protrusion has an outside diameter that is less than an outside diameter of the sidewall.

According to yet another embodiment of the present invention, a method for manufacturing a holder for a tealight candle includes the steps of injecting a thermoplastic resin into a mold and, with the mold, forming a container having a floor, a sidewall extending upward from the floor, and an annular protrusion formed on a bottom surface of the container. The annular protrusion has an outside diameter that is less than an outside diameter of the sidewall. The annular protrusion includes a first sidewall portion extending substantially perpendicular from the bottom surface, a first radiused portion extending from the first sidewall portion, and a second radiused portion extending from the first radiused portion to the bottom surface.

### BRIEF DESCRIPTION OF THE DRAWINGS

The present invention will be better understood from reading the following description of non-limiting embodiments, with reference to the attached drawings, wherein below:

FIG. 1 is a top, perspective view of a holder/cup for a tealight candle, according to an embodiment of the present invention.

FIG. 2 is a bottom, perspective view of the holder of FIG. 1.

FIG. 3 is another bottom, perspective view of the holder of FIG. 1.

FIG. 4 is another bottom, perspective view of the holder of FIG. 1.

FIG. 5 is yet another bottom, perspective view of the holder of FIG. 1.

FIG. 6 is a bottom, plan view of the holder of FIG. 1.

FIG. 7 is a side elevational view of the holder of FIG. 1.

FIG. 8 is an enlarged, perspective view of a bottom of the holder of FIG. 1.

FIG. 9 is another enlarged, perspective view of a bottom of the holder of FIG. 1.

FIG. 10 is a side, cross-sectional view of the holder of FIG. 1.

FIG. 11 is a top, perspective view a holder/cup for a tealight candle, according to another embodiment of the present invention.

FIG. 12 is a bottom, perspective view of the holder of FIG. 11.

FIG. 13 is a perspective illustration of the holder of FIG. 11.

FIG. 14 is a top plan illustration of the holder of FIG. 11.

FIG. 15 is a front elevational illustration of the holder of FIG. 11.

FIG. 16 is a side elevational illustration of the holder of FIG. 11.

FIG. 17 is a cross-sectional illustration of the holder of FIG. 11, taken along line A-A of FIG. 14.

### DETAILED DESCRIPTION OF THE PREFERRED EMBODIMENTS

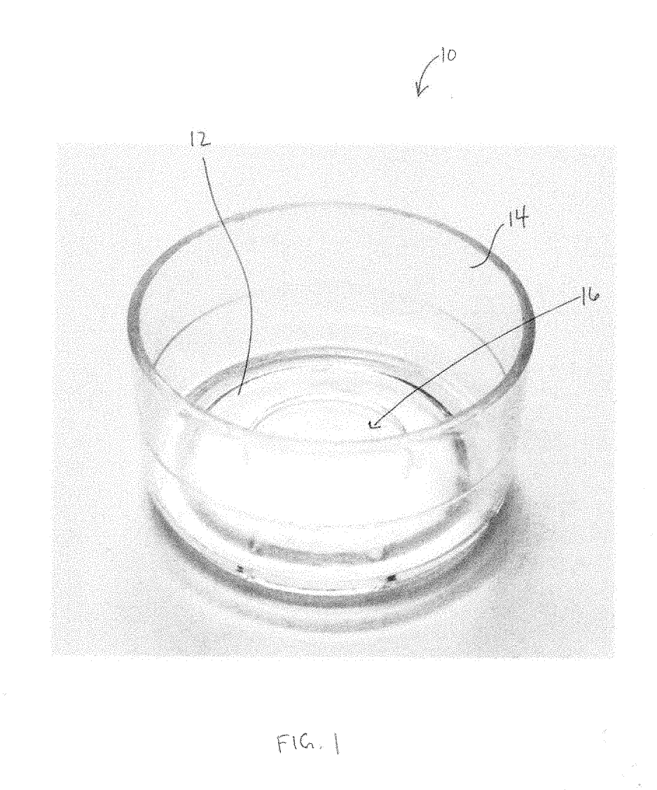

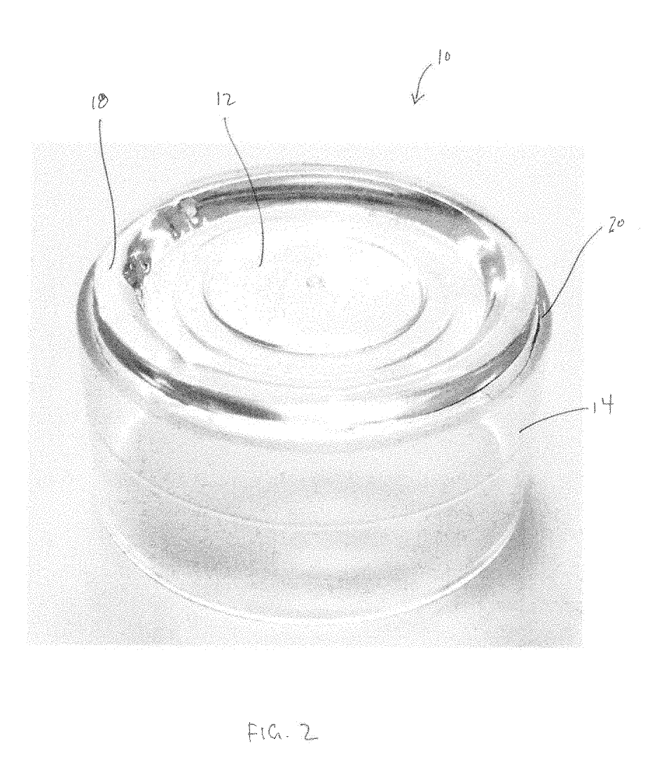

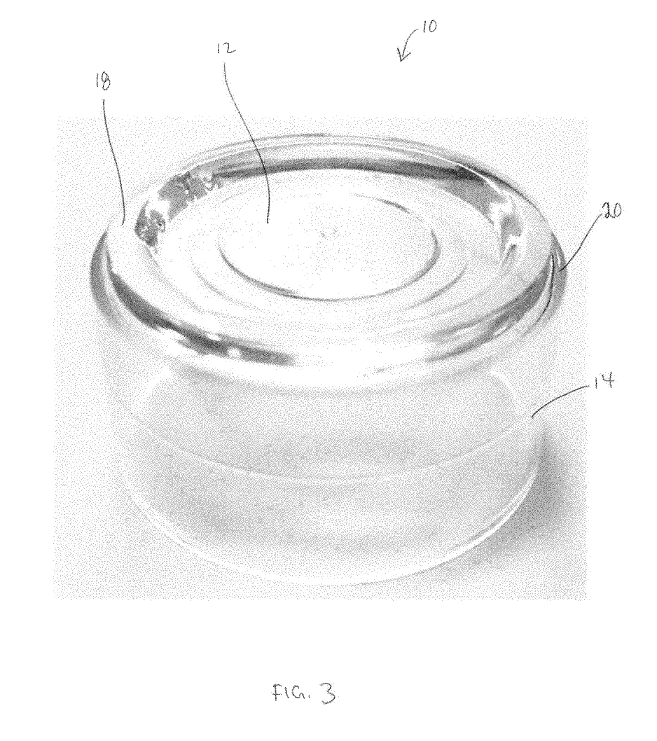

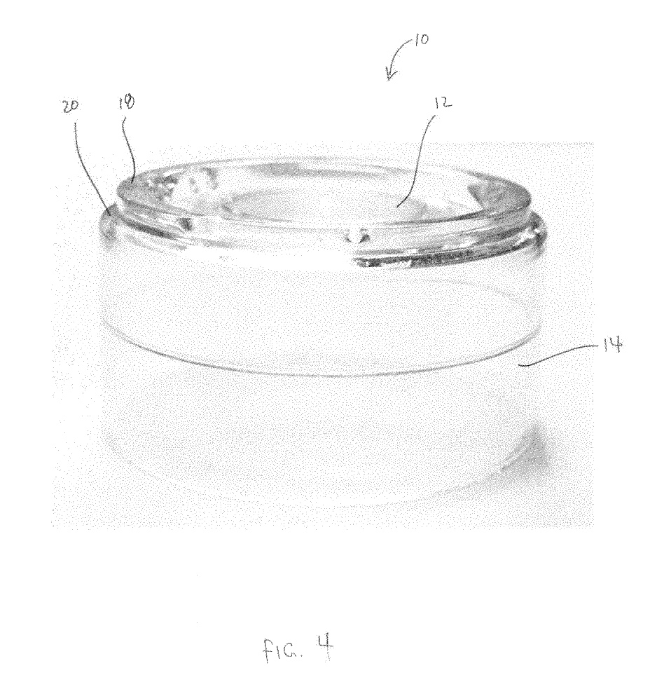

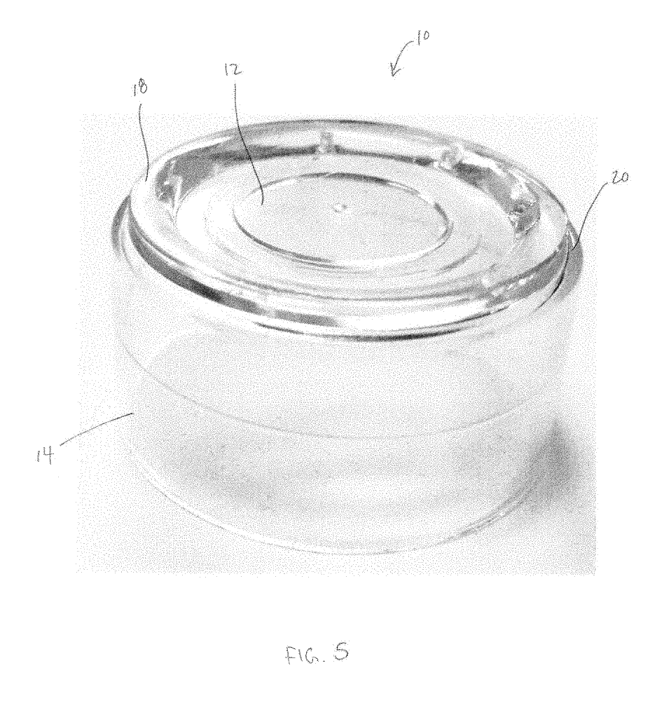

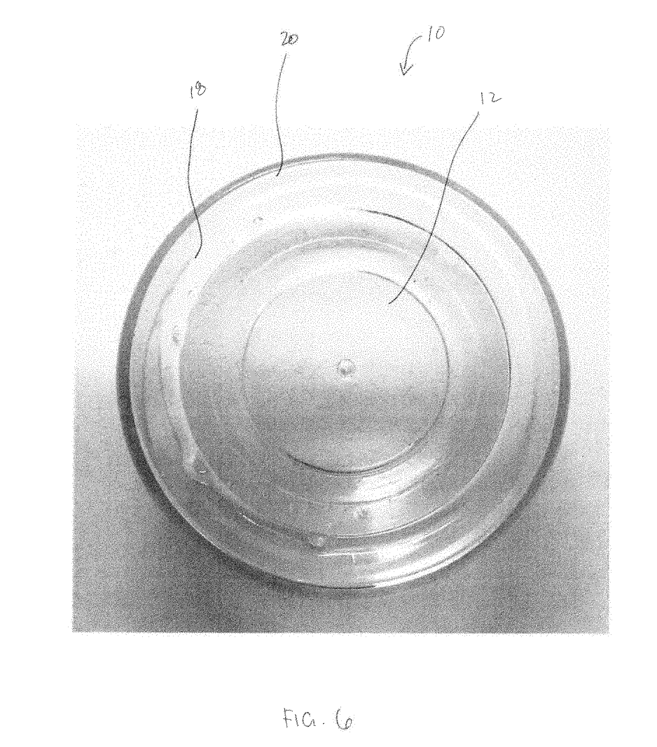

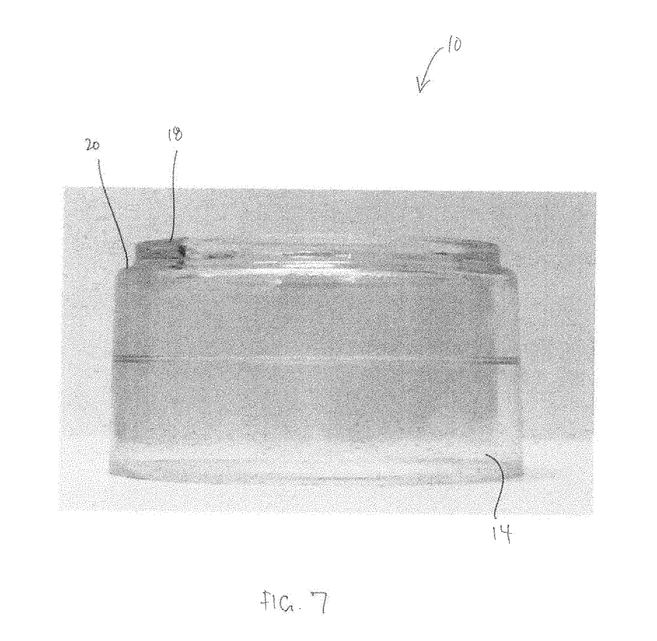

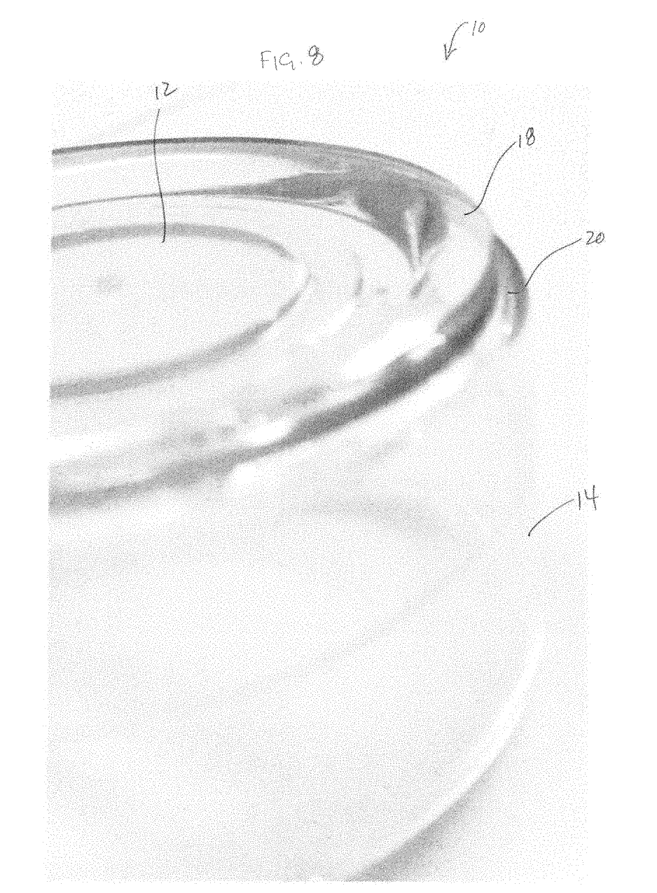

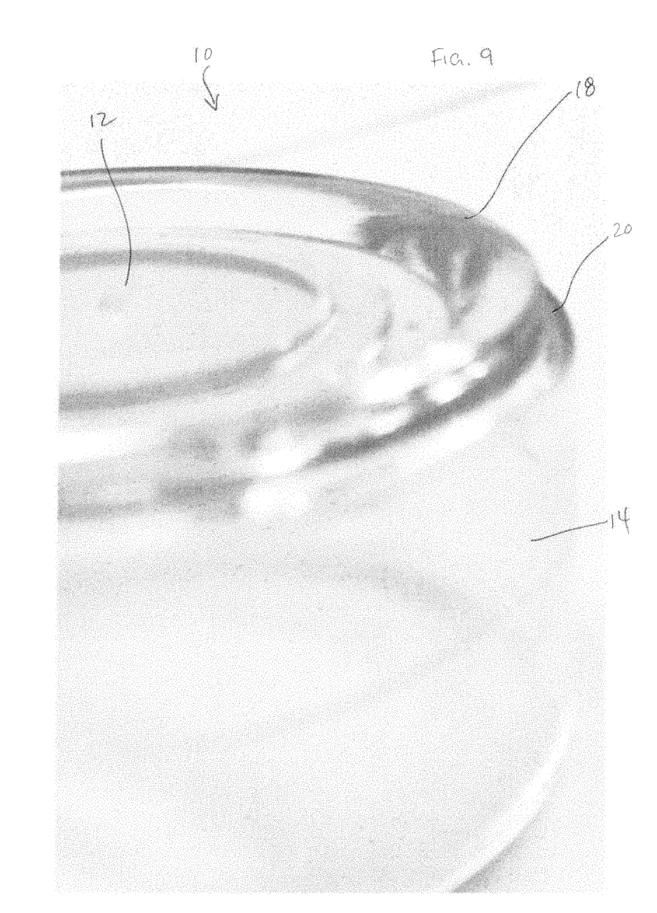

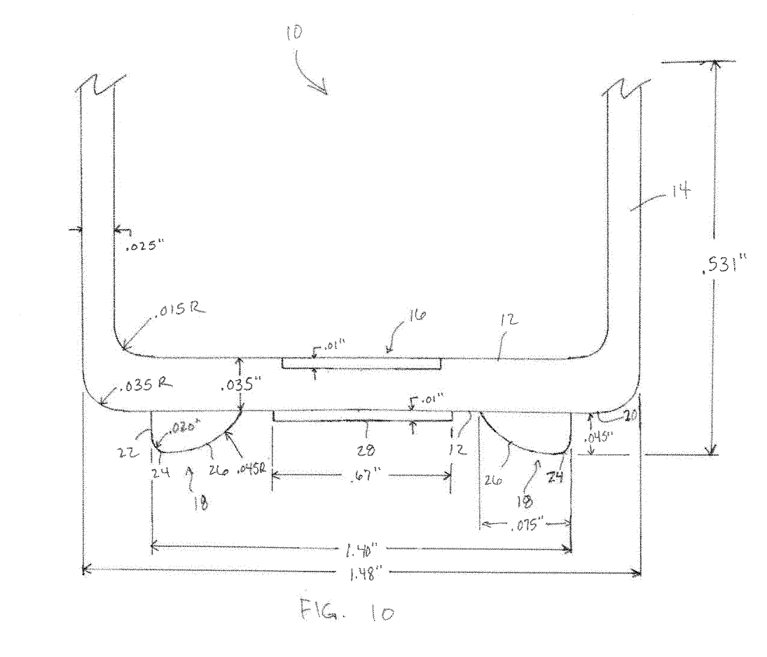

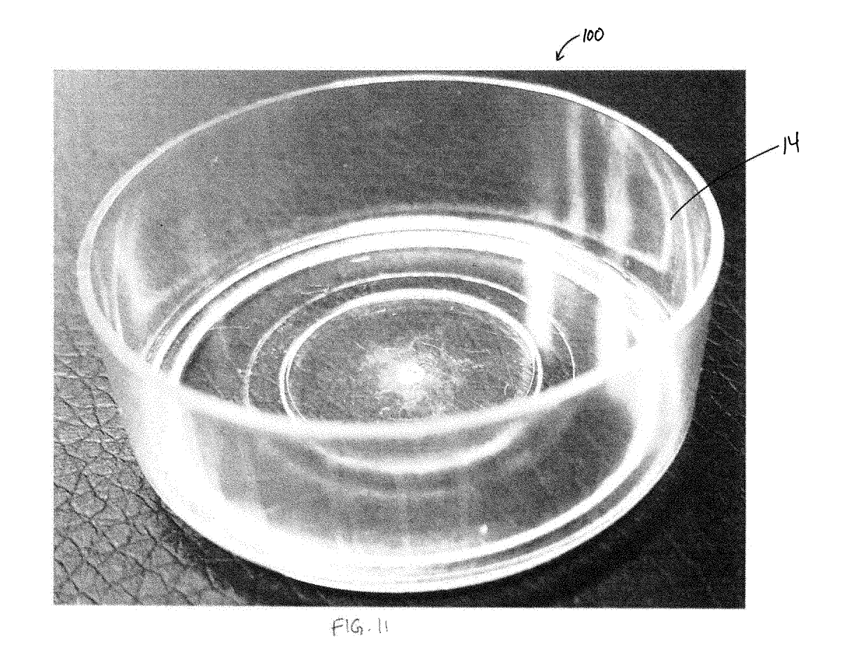

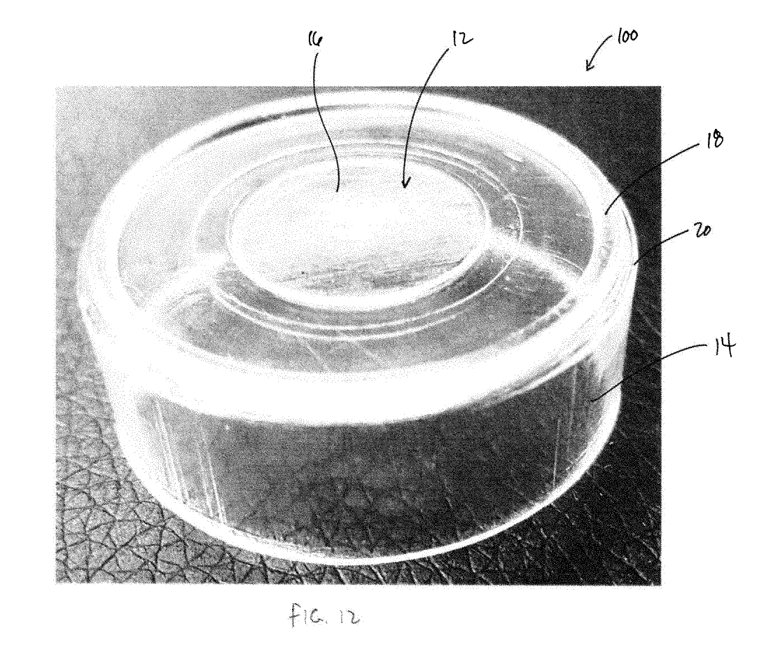

Referring to FIG. 1, a cup 10 for use with a tealight candle is depicted. The cup 10 is preferably made from a moldable thermoplastic plastic resin that is suitable for injection molding and exhibits good clarity, heat and ignition resistance. In an embodiment, the thermoplastic is clear polycarbonate. As illustrated therein, the cup 10 includes a generally planar floor 12 and an integral sidewall 14 extending upwardly from the floor 12, the floor 12 and sidewall 14 forming a generally cylindrical container into which wax can be introduced around a wick to form the tealight. A generally cylindrical recess or depression 16 is formed in the floor 12 for centering the wick and collecting wax as the candle burns, as is known in the art. In an embodiment, the recess 16 is approximately 0.01″ deep and approximately 0.65″ in diameter.

In the preferred embodiment, the sidewall 14 is approximately 0.025″ thick, which provides for a desired degree of rigidity and a simultaneously sleek and minimalist appearance. The interior sidewall 14 and floor 12 are preferably formed at their intersection with an approximately 0.015″ radius. In the preferred embodiment, the overall, outside diameter of the cup 10 is approximately 1.48″, approximately equivalent to a standard tealight.

Turning now to FIGS. 2-9, a bottom of the cup 10 is formed with an annular protrusion or foot 18 that extends downwardly from the bottom surface of the cup 10. The annular protrusion 18 is inset from the sidewall 14 and has an outside diameter that is less than the outside diameter defined by cylindrical sidewall 14. The annular protrusion 18 and bottom surface 12 of the cup therefore define a shoulder 20. In an embodiment, the outside diameter of the annular protrusion is approximately 1.40″. In an embodiment, the bottom corner of the cup 10 where the sidewall 14 meets the shoulder 20 has a radius of approximately 0.035″. As shown in FIGS. 2-9, the annular protrusion 18 is continuous and is devoid of any interruptions or breaks that could serve as catch points or the like on manufacturing lines, as discussed in detail hereinafter.

With reference to FIG. 10, the specific shape of the annular protrusion 18 is best shown. As shown therein, the annular protrusion includes a first sidewall portion 22 that extends substantially perpendicular from the bottom 12 of the cup 10, a first radiused 24 portion that extends from the distal end of the first sidewall portion 22, and a second radiused portion 26 that extends from the first radiused portion back to the bottom 12 of the cup 10. In the preferred embodiment, the annular protrusion extends approximately 0.045″ from the bottom surface of the cup 10 and is approximately 0.075″ wide. In the preferred embodiment, the first radiused portion 24 has a radius from about 0.005″ to about 0.020″, and more preferably about 0.020″, and the second radiused portion 26 has a radius of about 0.020″ to about 0.045″. As illustrated in FIG. 10, a bottom of the cup 10 may include a cylindrical protrusion 28 that does not extend further from the bottom of the cup 10 than the annular protrusion 18.

Importantly, it has been discovered that a plastic cup having these particular specifications is able to run at high speeds on existing tealight manufacturing lines without jamming, including at speeds in excess of those used with tin cups. In particular, by providing an integral ring 18 rather than a plurality of distinct feet, cup tipping or misalignment during production runs, which can result in jamming, is minimized. In addition, the distinct cross-sectional shape of the ring, with the first perpendicular leg portion 22, first radiused portion 24 and second radiused portion 26, allows the cup to easily transition between conveyor belts and other line components without tipping or jamming. The leg portion 22, first radiused portion 24 and second radiused potion 24 are preferably integrally formed.

In an embodiment, the overall height of the cup 10 is approximately 0.531″, although the cup 10 may be taller or shorter without departing from the broader aspects of the present invention. In an embodiment, the thickness of the sidewall 14 is a function of height, such that as the height is increased, the sidewall thickness is increased. In an embodiment, with a height of approximately 0.531″, the weight of the cup is approximately 2.45 grams.

Importantly, the present invention therefore provides a cup that is able to run on existing tealight manufacturing lines without significant jamming or throughput issues, and at speeds equal to or in excess of those utilized with existing tin cups. The ability to run at such high speeds is derived from the added robustness of polycarbonate material (as compared to tin), as well as the sturdiness provided by the shape, configuration and dimensional specifications of the annular protrusion 18. By being able to run at higher speeds, increased production may be realized, which can more than make up for the increased cost in polycarbonate over tin.

In addition to facilitating use on existing production lines, the configuration of the annular protrusion 18, and the shoulder 20, allows the cups 10 to be nested with one another for storage or transport.

As discussed above, the ability to manufacture tealights with clear plastic cups also allows the color of the wax received closely within the cup 10 to be appreciated by a user in a manner heretofore not seen in the art. This increases the overall aesthetics of the tealight.

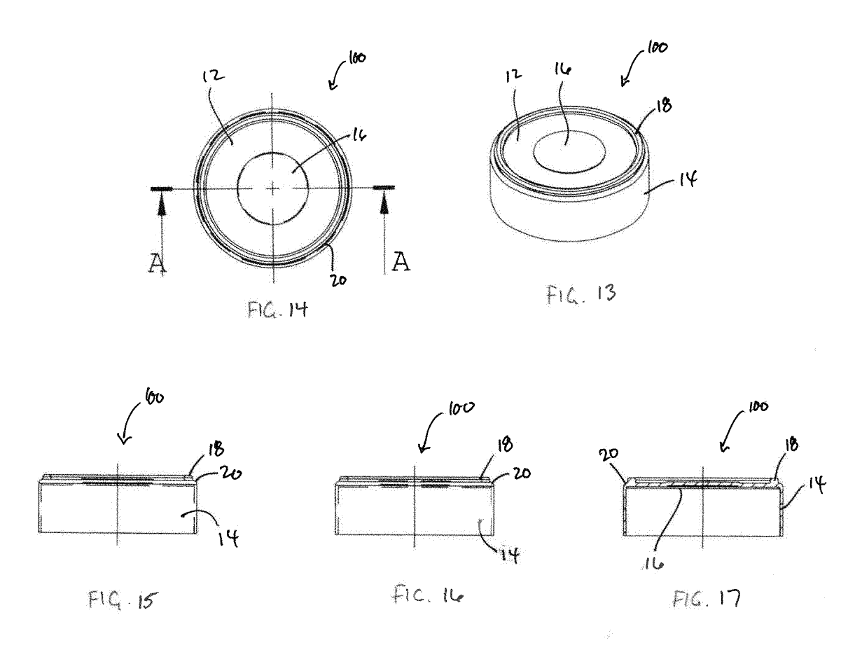

FIGS. 11-17 illustrate a tealight candle holder/cup 100 according to another embodiment of the present invention. The tealight candle holder/cup shown in these figures is substantially similar to the cup 10 discussed above in connection with FIGS. 1-10, where like reference numerals designate like parts. As illustrated therein, however, the sidewall 14 is of a reduced height a compared to the sidewall of the embodiments shown in FIGS. 1-10.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure

What is claimed is:

1. A holder for a tealight candle, comprising;
a floor;
a sidewall extending upward from said floor, said floor and said sidewall defining a generally cylindrical container having an open top; and
an annular protrusion on a bottom surface of said container.

2. The holder of claim 1, wherein:
said annular protrusion includes a first sidewall portion extending substantially perpendicular from said bottom surface, a first radiused portion extending from said first sidewall portion, and a second radiused portion extending from said first radiused portion to said bottom surface.

3. The holder of claim 2, wherein:
said first radiused portion has a radius of between about 0.005 inches to about 0.020 inches.

4. The holder of claim 3, wherein:
said second radiused portion has a radius of between about 0.020 inches to about 0.045 inches.

5. The holder of claim 2, wherein:
an outside diameter of said annular protrusion is less than an outside diameter of said container, thereby defining a shoulder on said bottom surface of said container between said sidewall and said annular protrusion.

6. The holder of claim 5, wherein:
an intersection between said shoulder and said sidewall defines has a radius of approximately 0.035 inches.

7. The holder of claim 5, wherein:
said outside diameter of said annular protrusion is approximately 1.40 inches; and
said outside diameter of said container is approximately 1.48 inches.

8. The holder of claim 1, wherein:
said holder is manufactured from a thermoplastic resin.

9. The holder of claim 8, wherein:
said thermoplastic resin is polycarbonate.

10. The holder of claim 9, wherein:
said sidewall is approximately 0.025 inches thick.

11. The holder of claim 4, wherein:
said annular protrusion extends approximately 0.045 inches from said bottom surface.

12. The holder of claim 1, wherein:
said sidewall is substantially rigid.

13. A holder for a candle, comprising:
a floor;
a sidewall extending upward from said floor, said floor and said sidewall defining a generally cylindrical container having an open top; and
an annular protrusion formed on a bottom surface of said container;
wherein said annular protrusion has an outside diameter that is less than an outside diameter of said sidewall.

14. The holder of claim 13, further comprising:
said holder is manufactured from a clear polycarbonate.

15. The holder of claim 13, wherein:
said annular protrusion extends approximately 0.045 inches from said bottom surface and has a width of approximately 0.075 inches.

16. The holder of claim 13, wherein:
said annular protrusion includes a first sidewall portion extending substantially perpendicular from said bottom surface, a first radiused portion extending from said first sidewall portion, and a second radiused portion extending from said first radiused portion to said bottom surface.

17. The holder of claim 16, wherein:
said first radiused portion has a radius of between about 0.005 inches to about 0.020 inches; and
said second radiused portion has a radius of between about 0.020 inches to about 0.045 inches.

18. The holder of claim 17, wherein:
said sidewall is substantially rigid.

19. A method for manufacturing a holder for a tealight candle, comprising the steps of:
injecting a thermoplastic resin into a mold; and
forming a container having a floor, a sidewall extending upward from said floor, and an annular protrusion formed on a bottom surface of said container;
wherein said annular protrusion has an outside diameter that is less than an outside diameter of said sidewall; and
wherein said annular protrusion includes a first sidewall portion extending substantially perpendicular from said bottom surface, a first radiused portion extending from said first sidewall portion, and a second radiused portion extending from said first radiused portion to said bottom surface.

20. The method according to claim 19, wherein:
said thermoplastic resin is a clear polycarbonate.
